(19) United States
(12) Patent Application Publication
(10) Pub. No.: US 2026/0329627 A1
(43) Pub. Date: Oct. 22, 2026

(54) METHOD, APPARATUS, DEVICE AND MEDIUM FOR TASK INTERACTION

(71) Applicant: Beijing Zitiao Network Technology Co., Ltd., Beijing (CN)

(72) Inventors: Qinghong CHEN, Beijing (CN); Yiqi XIAO, Beijing (CN); Jinning MAI, Beijing (CN)

(21) Appl. No.: 19/396,196

(22) Filed: Nov. 20, 2025

(30) Foreign Application Priority Data
Apr. 18, 2025 (CN) 202510497297.5

(51) Int. Cl. G06F 9/48; G06F 9/451

(52) U.S. Cl. CPC G06F 9/485; G06F 9/451

(57) ABSTRACT

According to embodiments of the disclosure, a method, an apparatus, a device, and a storage medium for task interaction are provided. The method includes: presenting, in an interface interacting with an agent, first information related to an execution process of a task in response to a request for the task of the agent, the request indicating task information of the task; causing execution of the task to be paused in response to a pause condition of the task being satisfied; and resuming the execution of the task in response to an adjustment to or resuming of the task received in a paused state of the task, where second information related to an execution process or an execution result of the resumed task is presented in the interface.

### CROSS-REFERENCE

The present application claims priority to Chinese Patent Application No. 202510497297.5, filed on Apr. 18, 2025 and entitled "METHOD, APPARATUS, DEVICE AND MEDIUM FOR TASK INTERACTION", the entirety of which is incorporated herein by reference.

### FIELD

Example embodiments of the present disclosure generally relate to the field of computers, and in particular, to a method, an apparatus, an electronic device, a computer-readable storage medium and a computer program product for task interaction.

### BACKGROUND

With the development of information technologies, more and more intelligent systems are capable of performing various complex tasks based on user input. These systems usually interact with users in a dialogue form and generate response content according to requests from a user in natural language, thereby forming question-answering dialogues. However, in practical applications, a user's goal is often not merely to obtain an answer, but to expect the system to perform complete planning and execution around a certain task. Therefore, how to drive a model based on a task objective to complete execution of a specific task and improve the structural degree and user controllability of the execution process becomes a problem worthy of attention.

### SUMMARY

In a first aspect of the present disclosure, a method for task interaction is provided, including: presenting, in an interface interacting with an agent, first information related to an execution process of a task in response to a request for the task of the agent, the request indicating task information of the task; causing execution of the task to be paused in response to a pause condition of the task being satisfied; and resuming the execution of the task in response to receiving an adjustment to or resuming of the task in a paused state of the task, where second information related to an execution process or an execution result of the resumed task is presented in the interface.

In a second aspect of the present disclosure, an apparatus for task interaction is provided, including: a first information presenting module configured to present, in an interface interacting with an agent, first information related to an execution process of a task in response to a request for the task of the agent, the request indicating task information of the task; an execution pausing module configured to cause execution of the task to be paused in response to a pause condition of the task being satisfied; and an execution resuming module configured to resume the execution of the task in response to receiving an adjustment to or resuming of the task in a paused state of the task, where second information related to an execution process or an execution result of the resumed task is presented in the interface.

In a third aspect of the present disclosure, an electronic device is provided. The device includes at least one processor; and at least one memory, the at least one memory is coupled to the at least one processor and stores instructions executable by the at least one processor, the instructions, when executed by the at least one processor, cause the device to perform the method of the first aspect.

In a fourth aspect of the present disclosure, a computer-readable storage medium is provided. The computer-readable storage medium stores computer-executable instructions, the computer-executable instructions are executable by a processor to implement the method of the first aspect.

In a fifth aspect of the present disclosure, a computer program product is provided, including computer-executable instructions, where the computer-executable instructions, when executed by a processor, implement the method of the first aspect.

It should be appreciated that the content described in the Summary section of the present disclosure is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment in which the embodiments of the present disclosure may be implemented;

FIGS. 2A -2I illustrate schematic diagrams of example interfaces for interacting with an agent according to some embodiments of the present disclosure;

FIG. 3 illustrates a flowchart of a process for task interaction according to some embodiments of the present disclosure;

FIG. 4 illustrates a block diagram of an apparatus for task interaction according to some embodiments of the present disclosure; and

FIG. 5 illustrates a block diagram of an electronic device capable of implementing one or more embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term "include/comprise" and similar terms should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". Other explicit and implicit definitions may also be included below.

Herein, unless explicitly stated, "performing a step in response to A" does not mean that the step is performed immediately after "A", but may include one or more intermediate steps.

It should be understood that the data involved in the technical solution (including but not limited to the data itself, acquisition or use of the data) should comply with requirements of corresponding laws, regulations and related provisions.

It should be understood that before using the technical solutions disclosed in the embodiments of the present disclosure, the user should be informed of the type, range of use, use scenarios, etc. of personal information involved in the present disclosure, and the authorization of the user should be obtained in an appropriate manner in accordance with relevant laws and regulations.

For example, in response to receiving an active request from a user, prompt information is sent to the user to clearly prompt the user that the requested operation will require access to and use of the user's personal information, so that the user may independently choose, based on the prompt information, whether to provide the personal information to software or hardware, such as an electronic device, an application, a server or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text form. In addition, the pop-up window may also include a selection control for the user to select "agree" or "disagree" to provide the personal information to the electronic device.

It should be understood that the above process of notifying and obtaining user authorization is only illustrative and does not constitute a limitation on the implementations of the present disclosure. Other manners that satisfy the relevant laws and regulations may also be applied to the implementations of the present disclosure.

As used herein, the term "model" may learn a correlation between respective inputs and outputs from training data, so that a corresponding output may be generated for a given input after the training is completed. The generation of the model may be based on machine learning techniques. Deep learning is a machine learning algorithm that uses multiple layers of processing units to process inputs and provide corresponding outputs. A neural network model is an example of a model based on deep learning. Herein, a "model" may also be referred to as a "machine learning model", a "learning model", a "machine learning network" or a "learning network", which terms are used interchangeably herein.

A "neural network" is a machine learning network based on deep learning. A neural network is capable of processing inputs and providing corresponding outputs, and it typically includes an input layer and an output layer, as well as one or more hidden layers between the input layer and the output layer. Neural networks used in deep learning applications typically include many hidden layers, thereby increasing the depth of the network. The layers of the neural network are connected in sequence, so that an output of a previous layer is provided as an input of a next layer, where the input layer receives an input of the neural network, and an output of the output layer serves as the final output of the neural network. Each layer of the neural network includes one or more nodes (also referred to as processing nodes or neurons), each processing input from the previous layer.

Generally speaking, machine learning may roughly include three stages, namely a training stage, a testing stage and an application stage (also referred to as an inference stage). In the training stage, a given model may be trained using a large amount of training data, and a set of parameter values may be updated through continuous iteration, until the model may obtain consistent inference from the training data that satisfies an expected objective. Through training, the model may be considered to be able to learn a correlation (also referred to as a mapping from input to output) from input to output from the training data. The parameter values of the trained model are determined. In the testing stage, a test input is applied to the trained model to test whether the model may provide a correct output, thereby determining the performance of the model. In the application stage, the model may be used to process an actual input and determine a corresponding output based on the parameter values obtained from training.

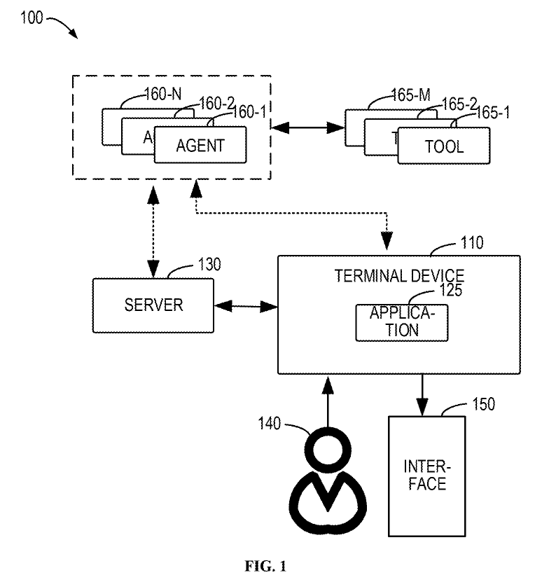

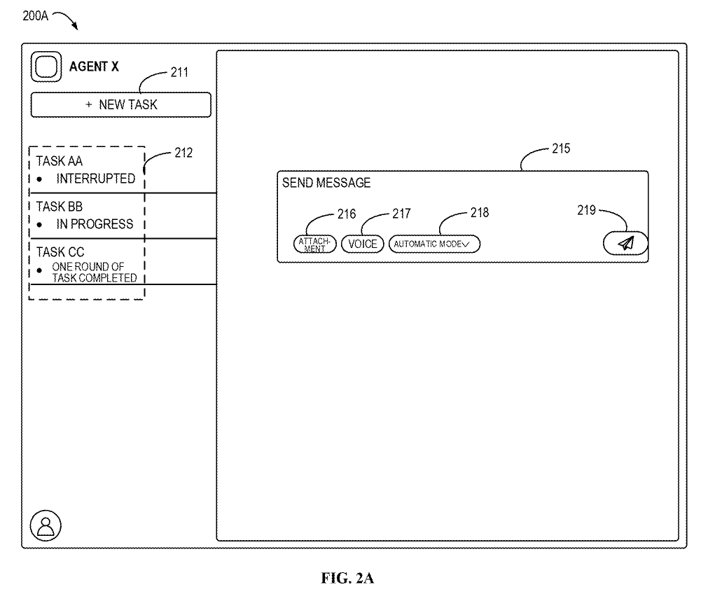

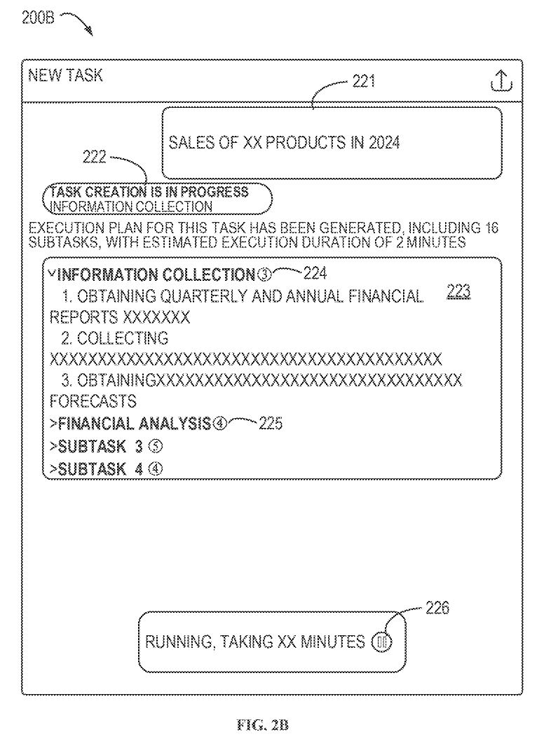

FIG. 1 illustrates a schematic diagram of an example environment 100 in which the embodiments of the present disclosure may be implemented. In this example environment 100, an application 125 is installed on a terminal device 110. A user 140 may interact with the application 125 via the terminal device 110 and/or an attachment device of the terminal device 110.

In some embodiments, the application 125 may be downloaded and installed on the terminal device 110. In some embodiments, the application 125 may also be accessed in other manners, such as via a web page. In the environment 100 of FIG. 1, in response to the application 125 being launched, the terminal device 110 may present an interface 150 of the application 125.

In some embodiments, the terminal device 110 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a TV receiver, a radio broadcast receiver, an e-book device, a game device, or any combination of the foregoing, including fittings and peripherals of these devices, or any combination thereof. In some embodiments, the terminal device 110 may also support any type of user-specific interface (such as a "wearable" circuit, etc.).

In some embodiments, the terminal device 110 communicates with a server 130 to implement service provision for the application 125. The terminal device 110 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a TV receiver, a radio broadcast receiver, an e-book device, a game device, or any combination of the foregoing, including fittings and peripherals of these devices, or any combination thereof. In some embodiments, the terminal device 110 may also support any type of user-specific interface (such as a "wearable" circuit, etc.). The application 125 may be various types of computing systems/servers capable of providing computing power, including but not limited to mainframes, edge computing nodes, computing devices in cloud environments, and so on.

In the embodiments of the present disclosure, the application 125 may provide an interaction function with an agent. The application 125 may be an application dedicated to providing agent services, or an application integrated with an agent (that is, other functions or services other than the agent may be provided). Although a single application is shown in FIG. 1, in practice, a plurality of applications may be installed on the terminal device 110.

In the present disclosure, agents 160-1, 160-2, ..., 160-N (collectively or individually referred to as agent 160) may be deployed locally on the terminal device 110 or deployed remotely. In the case of remote deployment, the terminal device 110 may directly invoke the agent, or may invoke the agent via the server 130.

In the embodiments of the present disclosure, the agent 160 may have an intelligent dialogue and task processing capability. The terminal device 110 provides an interface 150 that may present an interaction with the agent 160. In the interface 150, the user 140 may input a task request for the agent 160 through a natural language input (text input or a voice input), and may also upload an input online or offline file(s) for dialogue, to instruct the agent 160 to assist in completing various tasks.

In the embodiments of the present disclosure, the agent 160 may process a task indicated by the user 140 in response to a request from the user 140 during an interaction with the user 140. In some embodiments, during the task processing, the agent 160 may invoke one or more tools 165-1, 165-2, ..., 165-M (collectively or individually referred to as tool 165) to assist in task execution and task result provision according to task requirements. These tools 165 may be any type of tools, such as a weather query tool, a flight query tool, an information search tool, an online or offline database, an image processing tool, a chart generation tool, a web page production tool, and the like.

In some embodiments, the environment 100 may further include a management node for the plurality of agents 160-1, 160-2, ..., 160-N, and the management node may interact with the plurality of agents 160-1, 160-2, ..., 160-N. In some examples, the management node may determine a task requirement corresponding to a task request in response to the task request from the user 140. Then, the management node may assign the task request to an agent 160 that matches the task requirement based on the task requirement, to request the agent 160 to execute the task. In some other examples, the management node may further determine an execution plan of the task based on the task requirement. The execution plan of the task may indicate one or more subtasks required to complete the task. The management node may assign the one or more subtasks to one or more agents 160, and the one or more agents 160 respectively execute their corresponding subtasks. Regarding the management node, in some examples, the management node may be implemented by one of the plurality of agents 160-1, 160-2, ..., 160-N (in this case, the agent 160 is also referred to as a management agent 160). In some other examples, the management node may be implemented by a machine learning model, for example, by a language model (LM) or a large language model (LLM).

In some embodiments, the agent 160 may be constructed based on one or more machine learning models. In some embodiments, the machine learning models on which the agent 160 is based may at least include a language model (LM). These machine learning models include content generation models, which are capable of generating corresponding outputs based on model inputs. In some embodiments, the machine learning model based on the language model may receive a model input (e.g., a natural language and/or a machine language) in a text modality and/or a model input (e.g., an image, a voice, a video, etc.) in a non-text modality, and may obtain a corresponding model output based on the model input and a prompt, thereby completing task execution. The prompt here is used to guide the machine learning model to generate a solution to a user query indicated by the model input. In an application scenario for supporting user dialogue, an input from the user 140 may be provided to the machine learning model 160 as at least a part of the model input (other parts may include the prompt). The user input is treated as a question or a query request. Based on the model output, a corresponding response may be provided to the user 140.

It should be understood that the structure and functions of various elements in the environment 100 are described only for the purpose of illustration, without suggesting any limitations on the scope of the present disclosure.

As briefly mentioned above, a user may initiate a task request in an application. In some scenarios, the user may input a task requirement in a user interface provided by the application, and based on the task requirement of the user, the application may provide a service to the user that may satisfy the task requirement. Conventionally, the user may initiate a question in an application that provides a question answering service, to obtain a corresponding reply. However, through the operation mode, the user cannot perceive an execution process for the question. Further, in some scenarios, after the task is initiated, the user cannot control and modify the execution process of the task, and may only wait for the task to be completed. Alternatively, after the task is initiated, the user may choose to interrupt the current task and initiate a new task.

According to some embodiments of the present disclosure, an improved solution for task interaction is proposed. According to the solution of the embodiments of the present disclosure, if a request for a task of an agent is received, first information related to an execution process of the task is presented in an interface interacting with the agent, the request indicating task information of the task. In a case where a pause condition of the task is satisfied, execution of the task is caused to be paused. Further, if an adjustment to or resuming of the task is received in a paused state of the task, the execution of the task may be resumed. Correspondingly, if the execution of the task is resumed, second information related to an execution process or an execution result of the resumed task is presented in the interface.

In this way, by presenting the execution process and the execution result of the task in the interface interacting with the agent, the user can be informed of a decomposition process and an execution process of the task by the agent. Further, during the execution process or the decomposition process of the task, the user can pause, adjust, or resume the decomposition or execution of the task at any time, to obtain a result that meets the user's needs.

In the present disclosure, "trigger" refers to one or more interaction operations of the user on the terminal device. Further, these interaction operations may be triggered in the same user interface/pop-up window, or may be triggered in different user interfaces/pop-up windows. The present disclosure is not limited in this regard.

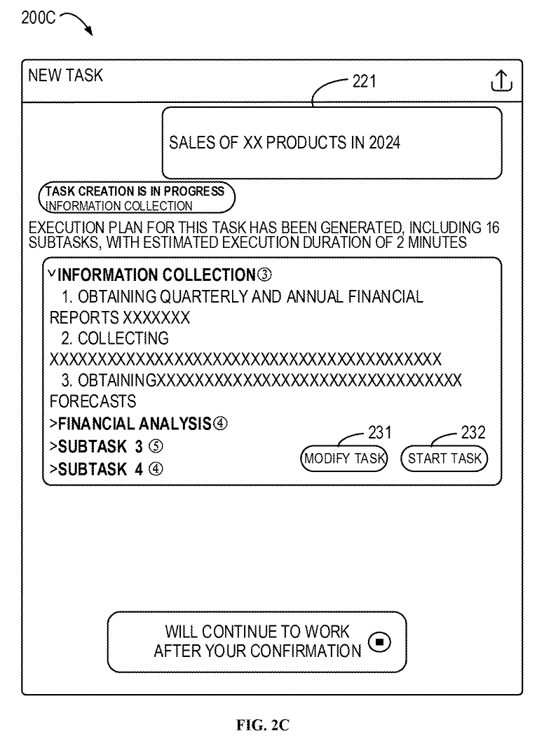

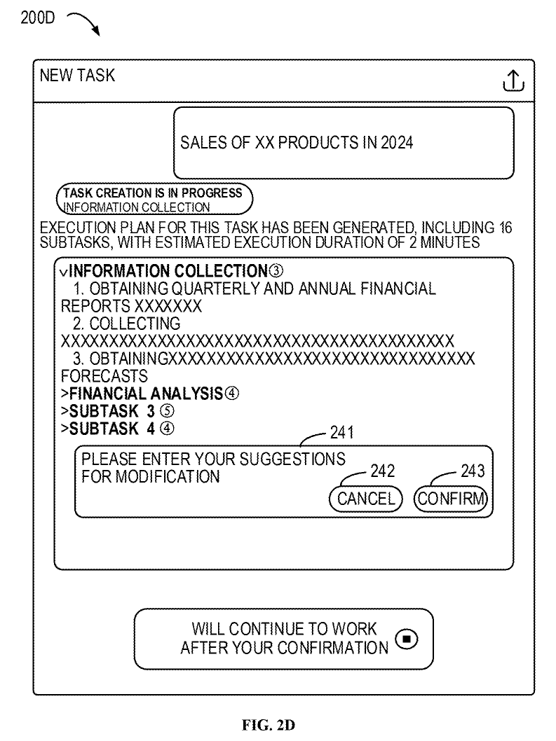

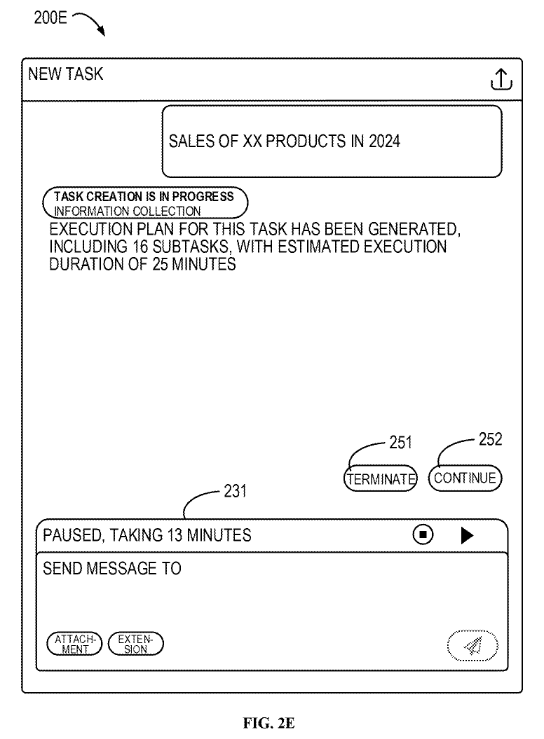

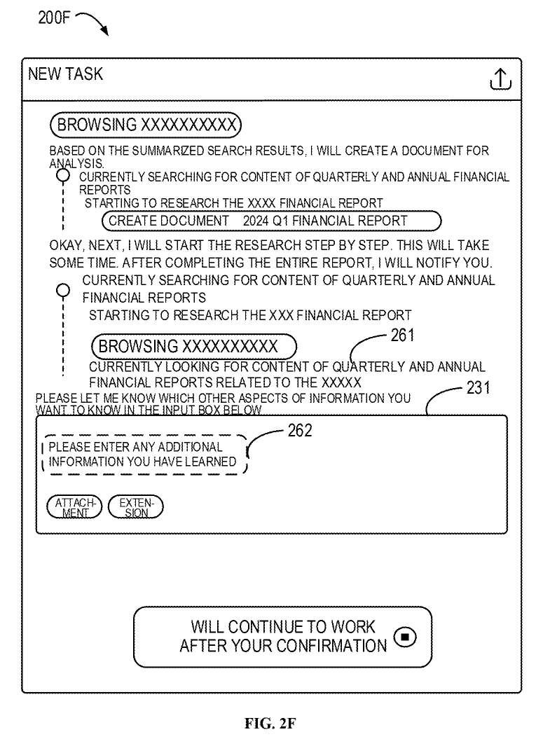

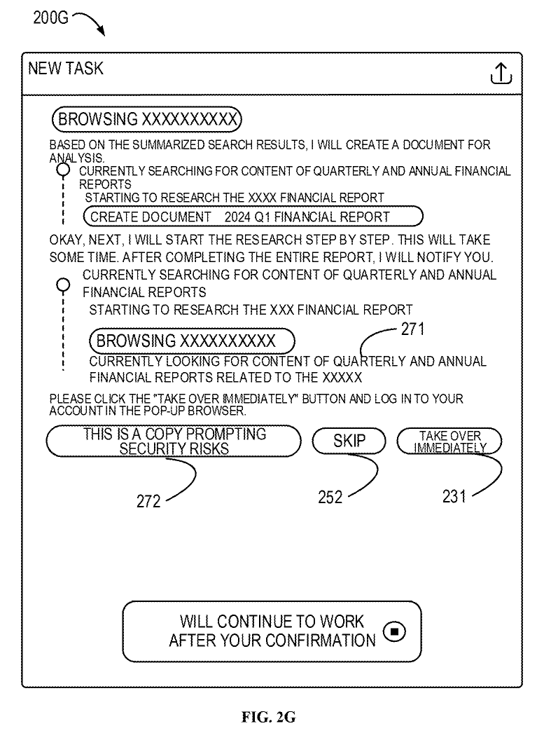

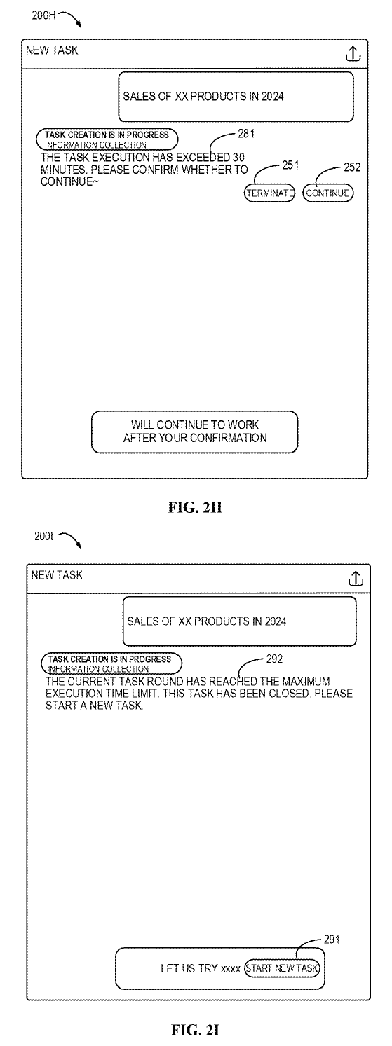

Some embodiments of the present disclosure will be described below with reference to the drawings. For ease of understanding, examples of interfaces for interacting with an agent in some embodiments of the present disclosure will be described below with reference to FIGS. 2A -2I. These example interfaces may be presented by the application 125 at the terminal device 110. It should be understood that the interfaces shown in the drawings are only examples, and there may actually be various interface designs. Each graphical element in the interface may have different arrangements and different visual representations, one or more elements therein may be omitted or replaced, and there may also be one or more other elements. The embodiments of the present disclosure are not limited in this regard.

An interface 200A shown in FIG. 2A may present an interaction interface 200A between the user 140 and the agent 160. In this interaction interface 200A, a request for a new task initiated by the user may be received. As shown in FIG. 2A, the user may trigger the new task by triggering a "new task" control 211. In response to the triggering on the "new task" control 211, a task-specific interaction interface is presented in the interface 200A, such as an interaction interface 200B shown in FIG. 2B, to initiate the new task in the interaction interface 200B. In some embodiments, an input area 215 for task input is further provided in the interface 200A, in which the user may input a request for the task to be triggered, and initiate the request for the task through a send control 219. The input area 215 may support text input, for example, inputting text in a text input box, and may also support voice input, for example, by triggering a voice control 217. In addition, the input area 215 may further provide an attachment control 216 to support uploading an attachment to indicate the task request of the user. In some embodiments, the interaction interface 200A further provides a task list 212 initiated for the agent 160, the task list 212 indicating various initiated tasks and execution states of the tasks (for example, an interrupted state, an in-progress state, a completed state, etc.).

In some embodiments, a plurality of operation modes of the user 140 and the agent 160 may be provided, and flexible switching between the plurality of operation modes is possible, for example, via a mode switching control 218 shown in FIG. 2A. In a case where a certain mode is triggered, a corresponding interaction area is presented to facilitate the interaction between the user 140 and the agent 160. Interaction manners between the user 140 and the agent 160 in different operation modes are different, so that interaction requirements in different application scenarios may be flexibly adapted. In some embodiments, the different operation modes may include an automatic mode and a collaboration mode. In the automatic mode, the execution of the task by the agent 160 may be automatically and continuously performed until the task is completed. In the collaboration mode, after completing an action of the task execution, the agent 160 may pause the execution of the task and provide modification and confirmation options, so that the user may check whether the execution of the current action is as expected and whether the execution of the action needs to be modified. If no modification is needed, after receiving confirmation from the user, the agent 160 will continue to execute the next action of the task, until the task is completed.

In some embodiments, the agent 160 may be in a paused state during the task execution process. Options such as modification and resuming may be provided during the paused state, so that the user may check whether the execution of the current action is as expected and whether the execution of the action needs to be modified. Then, in the case where the task is modified, the modified task may be delivered to the management agent 160. The management agent 160 may assign the modification of the task to other agents. During the task execution, the user 140 may add a new task, for example, add a subtask XX. In this scenario, the terminal device 110 may invoke the management agent 160 to add the subtask XX. After receiving the subtask XX, the management agent 160 may modify the entire task. Then, the management agent 160 may reassign the task to each agent. In some embodiments, the terminal device 110 may invoke an agent that may solve the subtask XX to process.

In some embodiments, the management agent 160 may determine a prompt corresponding to additional task information indicating a modification to or addition of the subtask. The prompt may be concatenated into an original prompt as a component of a system prompt (SP), so as to provide contextual guidance for subsequent task execution. Alternatively or additionally, the prompt corresponding to the additional task information is directly concatenated into a task prompt of the agent corresponding to the subtask, so that the corresponding agent may consider new context content when executing the task.

After triggering the request for the task of the agent, the terminal device 110 presents the interaction interface 200B shown in FIG. 2B. In the interaction interface 200B, the request for the task initiated by the user, for example, a message 221, may be presented, and task execution information when the task is executed by the agent may also be presented. The task execution information may be presented in the interaction interface 200B in the form of one or more messages. During the execution of the task, the agent 160 may analyze the task request initiated by the user to determine a task requirement, thereby generating an execution plan for the task. The execution plan of the task may indicate one or more subtasks required to complete the task. In order to let the user better understand the execution process of the task by the agent, a message 221 indicating the generation of the execution plan may be presented in the interaction interface 200B. After the execution plan is determined, a message 223 indicating each subtask (for example, subtask 224, subtask 225, and other subtasks) in the execution plan may be presented in the interaction interface 200B. Next, the agent 160 will automatically continue to execute each subtask or in response to the confirmation from the user, and the execution process and the execution result of each subtask may be presented in the interaction interface 200B. After the execution of the entire task is completed, the execution result of the task or an access entry to the execution result (if the execution result needs to jump to another interface for presentation) may be presented in the interaction interface 200B. In this way, during the execution process of the entire task, the user can intuitively understand how the agent decomposes the task requirement of the user and the specific execution steps of each subtask, so that it is convenient for the user to confirm or adjust the execution process of the task or subtask, thereby obtaining an expected execution result.

In some embodiments, a process of determining one or more subtasks required to complete a task in an execution plan of the task based on a task request from the user 140 may be implemented by a machine learning model deployed at or invoked by the server 130. Further, after determining the specific task execution plan, the machine learning model may assign each subtask to one or more suitable agents 160 for specific task execution.

Alternatively or additionally, the task request from the user may also be sent to the management agent 160. The process of determining one or more subtasks in the execution plan of the task may be implemented by the management agent 160. The management agent 160 may be configured to parse the task request from the user based on the task request from the user 140, thereby determining one or more subtasks required to complete the task in the execution plan of the task. Further, the management agent 160 may assign the subtasks to one or more suitable agents 160 for specific task execution according to different task execution requirements and capabilities.

Some example embodiments of the present disclosure will be described below with continued reference to the drawings. The embodiments involved in the present disclosure may be implemented at the terminal device 110. It should be noted that the operations performed by the terminal device 110 may be specifically performed by a related application (for example, the application 125) installed on the terminal device 110. Some operations described with reference to the terminal device 110 may require the assistance of the server 130 to complete.

Herein, the terminal device 110 deploys an application 125 that supports a task processing function, and the user 140 may use the application 125 to process some tasks, for example, including but not limited to information query (for example, acquisition of real-time information such as weather forecast and news summary), data processing (for example, analysis of sales report in quarter XX), code execution (for example, generation and execution of simple code segments), and the like. However, these are only illustrative, and the present disclosure is not limited thereto.

In the embodiments of the present disclosure, the terminal device 110 causes the execution of the task to be paused if it is determined that the pause condition of the task is satisfied. In some embodiments, if the terminal device 110 determines that the pause condition of the task is satisfied, at least one interaction element may be presented in the interface, where the execution of the task is paused. The at least one interaction element is at least configured to adjust or resume the task in the paused state of the task. In some scenarios, during a process in which the terminal device 110 invokes the agent 160 to determine a task plan of the task and execute the task, the user 140 may pause and adjust the task at any time, to obtain a result that meets the needs of the user 140. In a scenario where the terminal device 110 needs the user 140 to input additional task information or take over, the progress of the task may be paused, and the execution of the task may be adjusted or resumed based on a next interaction operation of the user 140. In a scenario where the execution duration of a certain subtask of the task exceeds a duration threshold, the terminal device 110 may pause the progress of the task, and adjust or resume the execution of the task based on the next interaction operation of the user 140. The above scenarios are only illustrative, and the present disclosure is not limited thereto. The conditions under which the terminal device 110 pauses the task and how the user 140 may perform task interaction with the agent 160 for the task in the paused state will be described in detail below with reference to the drawings.

In the embodiments of the present disclosure, the terminal device 110 resumes the execution of the task if the adjustment to or resuming of the task is received in the paused state of the task. Correspondingly, if the terminal device 110 determines the resuming of the execution of the task, second information related to the execution process or the execution result of the resumed task may be presented in the interface. In some embodiments, the terminal device 110 may determine that the execution of the task is resumed based on an interaction operation of the user 140 after the execution of the task is paused. Furthermore, the terminal device 110 may continue to present information related to the execution process or the execution result of the task in the interface (such as the example interface 200B).

The conditions under which the terminal device 110 pauses a task and how the user 140 may perform task interaction with the agent 160 for the task in the paused state will be described below with reference to FIGS. 2B -2I.

In some embodiments, in a case where the terminal device 110 invokes the agent 160 to generate a task plan of a task, it may be determined that the pause condition of the task is satisfied, thereby pausing the execution of the task. Correspondingly, the terminal device 110 may present task information indicating at least one subtask indicated by the task plan in the interface. The terminal device 110 may present a first interaction element and a fifth interaction element for starting execution of the task plan in the interface. In some embodiments, the first interaction element is configured to trigger an adjustment to the task information of the task in the paused state of the task. The first interaction element may be configured to receive additional task information triggered to be input to the task, that is, adjust the task information of the task based on the additional task information. In some examples, the at least one subtask is determined during the execution of the task. After requesting the execution of the task, the agent 160 may first analyze the request from the user and determine the execution plan of the task. The execution plan of the task indicates one or more subtasks included in the task.

As shown in example interfaces 200C to 200D in FIGS. 2C -2D, in a case where the terminal device 110 determines that the task has been decomposed into subtask 223, subtask 224, subtask 3, subtask 4, and other subtasks, task information 223 corresponding to each subtask may be presented in the interface (such as the example interface 200C). In this scenario, the terminal device 110 may determine that the current task is in the paused state, and may present an interaction element 231 (for example, a "modify task" control) and an interaction element 232 (for example, a "start task" control) in the interface (such as the example interface 200C). The user 140 may click on the interaction element 232 to allow the terminal device 110 to start executing each subtask.

If the terminal device 110 receives that the user 140 clicks on the interaction element 231, an input box 241 may be presented in the interface (such as the example interface 200D). The user 140 may input additional task information of the task into the input box 241, for example, the user 140 may input some modification suggestions. Although not shown in the figure, in addition to direct input in the text input box, the interaction element 241 may also support other input manners, such as voice input, or providing modification suggestions by uploading an attachment, providing a web page link, or the like. Subsequently, if the terminal device 110 receives the additional task information input by the user 140, the agent 160 may be used to continue the execution of the task based on the additional task information input by the user 140 and information about a task execution process or an execution result that is currently generated.

In some embodiments, the terminal device 110 may further present a cancel control 242 and a confirm control 243 in the interaction interface 200D. The cancel control 242 is used to undo the modification process carried out by the current input box 241 and return to the presentation interface of the original task plan when the user gives up the modification operation. The confirm control 243 is used to confirm the submission of the modified content after the user completes the input.

In some embodiments, referring to example interfaces 200B and 200E shown in FIGS. 2B and 2E, during the execution of the task, the terminal device 110 may present a pause control 226 in the interface. If the terminal device 110 receives the triggering on the pause control 226, it may be determined that the pause condition of the task is satisfied, thereby pausing the execution of the task. That is, during the execution of the task, the user 140 may click on the pause control 226 to cause the task to be in the paused state. For example, during a process in which the terminal device 110 generates the task plan, if the user 140 needs to supplement some information, the user 140 may click on the pause control 226 to supplement this information based on the interaction element (for example, the "input box") provided by the terminal device 110. For another example, during a process in which the terminal device 110 executes the subtask, if the user 140 needs to supplement some information, the user 140 may also click on the pause control 226 to supplement this information based on the interaction element (for example, the "input box") provided by the terminal device 110. In these scenarios, the terminal device 110 may present an interaction element 231 (for example, an "input box") and an interaction element 252 (for example, a "continue" control) in the interface (such as the example interface 200E). The interaction element 252 (that is, the second interaction element) may be configured to trigger the resuming of the execution of the task in the paused state of the task.

In some embodiments, if the terminal device 110 receives the additional task information via the first interaction element, the execution of the task may be resumed. Correspondingly, the terminal device 110 may present second information related to an execution process or an execution result of the resumed task in the interface, where the second information is determined based on the additional task information and the first information. As shown in FIG. 2E, the user 140 may input requirement information of the user 140 into the interaction element 231 (for example, the "input box") presented in the interface (such as the example interface 200E), so that the execution of the task is resumed. If the terminal device 110 receives the additional task information input by the user 140, the agent 160 may be used to generate the second information based on the additional task information input by the user 140 and information about a task process that has been executed or information about an execution result that has been generated for the current task. Correspondingly, the terminal device 110 may continue to present the second information in the interface.

In some embodiments, if the terminal device 110 receives the triggering of the interaction element 252 (for example, the "continue" control) by the user 140, the execution of the task may also be resumed. At this time, since the user 140 does not input the additional task information, the second information that continues to be presented in the interface is generated by the agent 160 based on the previous first information and the execution plan of the task. In some embodiments, if the terminal device 110 detects that the execution of the task is paused, an interaction element 251 (for example, a "terminate" control) for stopping the execution of the task may be presented in the interface (such as the example interface 200E). If the terminal device 110 receives the triggering of the interaction element 251 (for example, the "terminate" control) by the user 140, the execution of the task may be terminated. Therefore, the user can interrupt, adjust, or resume the execution of the task at any time, to obtain a result that meets the user's needs.

In some embodiments, the agent 160 may gradually execute these subtasks based on the determined execution plan, thereby gradually completing the execution of the entire task. In some embodiments, in order to achieve human-computer collaboration and dynamic control during the task execution process and enhance the controllability of the user on the task execution process of the agent, after the current action of the agent 160 is completed, an intermediate interaction stage may be entered. At this stage, the terminal device 110 may cache the execution result of the current action, and pause the automatic advancement of subsequent actions in the task process. In the intermediate interaction stage, the user 140 may adjust the execution of the current action, for example, modifying, replacing, or regenerating the execution content. The task interaction process in the intermediate interaction stage will be described below with reference to FIG. 2F.

Referring to an example interface 200F shown in FIG. 2F, during the execution of the task, if the terminal device 110 determines that a third subtask (for example, subtask 261) in the at least one subtask of the task requires auxiliary information (that is, additional task information), it may determine that the pause condition of the task is satisfied, thereby pausing the execution of the task. That is, during the execution of the task, if the terminal device 110 determines that some additional task information (for example, supplementing constraint conditions, explaining expected structure, adding missing subtasks, etc.) needs to be collected from the user 140, the task may be caused to be in the paused state. In some embodiments, if the terminal device 110 receives the auxiliary information, the execution of the third subtask may be resumed. In some embodiments, if the terminal device 110 determines that some additional task information needs to be collected from the user 140, the user 140 may be provided with the interaction element 231 for acquiring the auxiliary information (that is, additional task information). In some embodiments, the interaction element 231 may present information of an input box to guide the user 140 to input. After the user 140 confirms the input auxiliary information, the execution of the task is resumed. In some embodiments, the terminal device 110 may further present prompt information 262 in the interface in association with the interaction element 231 (for example, the "input box"), which is used to prompt the user 140 that the user's own requirement information may be input into the interaction element 231 (for example, the "input box").

In some embodiments, if the terminal device 110 receives the auxiliary information via the first interaction element, the execution of the third subtask may be resumed. Correspondingly, the terminal device 110 may present second information related to the execution process or the execution result of the task in the interface, where the second information is determined based on the auxiliary information and the first information. As shown in FIG. 2F, the user 140 may input the requirement information of the user 140 into the interaction element 231 (for example, the "input box") presented in the interface (such as the example interface 200F), so that the execution of the subtask 261 is resumed. If the terminal device 110 receives the auxiliary information input by the user 140, the agent 160 may be used to generate the second information based on the auxiliary information input by the user 140 and information about a task process that has been executed or information about an execution result that has been generated for the current task. Correspondingly, the terminal device 110 may continue to present the second information in the interface. Therefore, the terminal device 110 can interrupt the execution of the task, allowing the user to choose to adjust or resume the execution of the task, thereby providing the user with a result that meets the user's needs.

During the execution of the task, the execution of some subtasks included in the task may require the access permission for an information source. In this scenario, the terminal device 110 may pause the execution of the task and provide the user 140 with an entry for authorization. The task interaction in this scenario will be described below with reference to FIG. 2G.

Referring to an example interface 200G shown in FIG. 2G, during the execution of the task, if the terminal device 110 determines that a first subtask (for example, subtask 271) in the at least one subtask requires an access permission for an information source, it may be determined that the pause condition of the task is satisfied, thereby causing the execution of the task to be paused. That is, during the execution of the task, if the terminal device 110 determines that the subtask 271 requires the access permission for the information source, the execution of the task may be paused. In this scenario, the terminal device 110 may present an interaction element 231 (for example, a "take over immediately" control) and an interaction element 252 (for example, a "skip" control) in the interface (such as the example interface 200G). The interaction element 231 (for example, the "take over immediately" control) may be an entry for authorizing the information source to be accessible.

In some embodiments, if the terminal device 110 receives an access authorization for the information source to be accessed, the execution of the first subtask may be resumed. In some embodiments, if the terminal device 110 receives the triggering of the interaction element 231 (for example, the "take over immediately" control), a configuration panel may be presented. The configuration panel may receive the access authorization for the information source to be accessed, as additional task information. In some examples, the user 140 may authorize, through the configuration panel, that the information source may be accessed by the terminal device 110. For example, the user 140 may perform authorization by scanning a predetermined code corresponding to the information source, inputting a mobile phone number, or the like. However, these are only illustrative, and the present disclosure is not limited thereto.

Furthermore, if the terminal device 110 receives the access authorization via the configuration panel, the execution of the first subtask may be resumed. Correspondingly, the terminal device 110 may present second information related to the execution process or the execution result of the resumed task in the interface, where the second information is determined based on information obtained from the information source and the first information. As shown in FIG. 2G, the user 140 may click on the interaction element 231 (for example, "take over immediately") to perform the access authorization for the information source, so that the execution of the subtask 271 is resumed. If the terminal device 110 determines that the user 140 has authorized the information source to be accessible, the agent 160 may be used to generate the second information based on the information obtained from the information source and information about a task process that has been executed or information about an execution result that has been generated for the current task. Correspondingly, the terminal device 110 may continue to present the second information in the interface.

In some embodiments, if the terminal device 110 receives the resuming of the task in the paused state of the task, the execution of the first subtask may be skipped, and a second subtask subsequent to the first subtask may be continued to be executed. In some embodiments, if the terminal device 110 receives the triggering of the interaction element 252 (for example, the "skip" control) by the user 140, the execution of the first subtask may be skipped. Correspondingly, the terminal device 110 continues to execute the second subtask subsequent to the first subtask. As shown in the example interface 200G in FIG. 2G, if the user 140 clicks on the interaction element 252 (for example, the "skip" control), the terminal device 110 may be caused to skip the execution of the subtask 271 and continue to execute the subsequent subtask of the subtask 271.

In some embodiments, if the terminal device 110 receives the triggering of the interaction element 252 (for example, the "skip" control) by the user 140, the execution of the task may also be resumed. That is to say, in the case where the information authorization cannot be obtained, some or all steps of the first subtask may need to be skipped. At this time, after the execution of the task is resumed, the second subtask subsequent to the first subtask may be continued to be executed. The second information that continues to be presented in the interface is generated by the agent based on the previous first information and the execution of the second subtask. In some embodiments, if the terminal device 110 determines that the execution of the subtask requires the access permission for the information source, prompt information 272 for prompting the user to confirm the authorization may be presented in the interface (such as the example interface 200G). Therefore, during the execution of the task, the agent can invoke other information sources that the user has authorized, thereby improving the accuracy of the result.

If the execution duration of the task and the subtasks of the task exceeds the duration threshold, the terminal device 110 may also cause the task to be in the paused state. The task interaction process in this case will continue to be described below with reference to FIGS. 2H -2I.

In some embodiments, if the terminal device 110 determines that the execution duration of a fourth subtask in the at least one subtask is longer than a first duration threshold, it may be determined that the pause condition of the task is satisfied, thereby causing the execution of the task to be paused. Correspondingly, the terminal device 110 may present a second interaction element and a third interaction element in the interface, where the third interaction element is configured to trigger stopping the execution of the task. As shown in an example interface 200H in FIG. 2H, if the terminal device 110 determines that the execution duration of the fourth subtask (for example, XX subtask) is longer than the first duration threshold (for example, 30 minutes or any other appropriate duration threshold), the task may be caused to be in the paused state.

In this scenario, the terminal device 110 may present an interaction element 252 (for example, a "continue" control) in the interface (such as the example interface 200H) for resuming the execution of the task. The terminal device 110 may present an interaction element 251 (for example, a "terminate" control) in the interface (such as the example interface 200H) to trigger stopping the execution of the task. In some embodiments, the terminal device 110 may further present, in the interface (such as the example interface 200H), prompt information 281 for prompting the user 140 that the execution of the current task exceeds the duration threshold. In some embodiments, if the terminal device 110 receives the triggering for the stopping of the task, the execution of the task may be stopped. In some embodiments, if the terminal device 110 receives the triggering of the third interaction element, the execution of the task may be stopped. That is, the user 140 may click on the interaction element 251 (for example, the "terminate" control) to stop the execution of the task.

In some embodiments, if the terminal device 110 receives the resuming of the task in the paused state of the task, the execution of the task may be resumed to continue to execute the fourth subtask or start a fifth subtask subsequent to the fourth subtask. In some embodiments, if the terminal device 110 receives the triggering of the second interaction element, the execution of the task may be resumed to continue to execute the fourth subtask or start the fifth subtask subsequent to the fourth subtask. Correspondingly, the second information presented by the terminal device 110 in the interface is determined based on the execution process or the execution result of the fourth subtask or the fifth subtask. As shown in FIG. 2H, the user 140 may click on the interaction element 252 (for example, the "continue" control) to cause the execution of the task to be resumed. That is, if the terminal device 110 receives that the user 140 clicks on the interaction element 252 (for example, the "continue" control), the fourth subtask may continue to be executed. Alternatively, if the terminal device 110 receives that the user 140 clicks on the interaction element 252 (for example, the "continue" control), the subtask subsequent to the fourth subtask may be caused to be executed. If the terminal device 110 receives that the user 140 clicks on the interaction element 252 (for example, the "continue" control), the agent 160 may be used to generate the second information based on information about a task process that has been executed or information about an execution result that has been generated for the current task. Correspondingly, the terminal device 110 may continue to present the second information in the interface.

In some embodiments, the terminal device 110 may stop the execution of the task if it is determined that the total execution duration of the task is longer than a second duration threshold. In some embodiments, if the terminal device 110 determines that the total execution duration of the task is longer than the second duration threshold, a sixth interaction element may be presented in the interface, where the sixth interaction element is used to trigger initiating a new task with the agent. As shown in an example interface 200I in FIG. 2I, if the terminal device 110 determines that the total execution duration of the task is longer than the second duration threshold (for example, 1.5 hours or any other appropriate duration threshold), the task may be caused to be in the paused state. In this scenario, the terminal device 110 may present an interaction element 291 (for example, an “initiate new task" control) in the interface (such as the example interface 200I) for initiating a new task with the agent 160.

In some embodiments, if the terminal device 110 determines that the total execution duration of the task is longer than the second duration threshold, prompt information for prompting to initiate a new task may be presented in the interface. As shown in the example interface 200I in FIG. 2I, the terminal device 110 may present prompt information 292 in the interface (such as the example interface 200I) to prompt the user 140 that the new task with the agent 160 may be initiated.

In summary, according to the present disclosure, the execution process and the execution result of the task may be presented in the interface interacting with the agent, so that the user may be informed of the decomposition process and the execution process of the task by the agent. Further, during the execution of the task, the agent may invoke other information sources that the user has authorized, thereby improving the accuracy of the result. In this way, during the execution of the task, the decomposition or execution of the task can be interrupted, adjusted, or resumed at any time, thereby providing the user with a result that meets the user's needs.

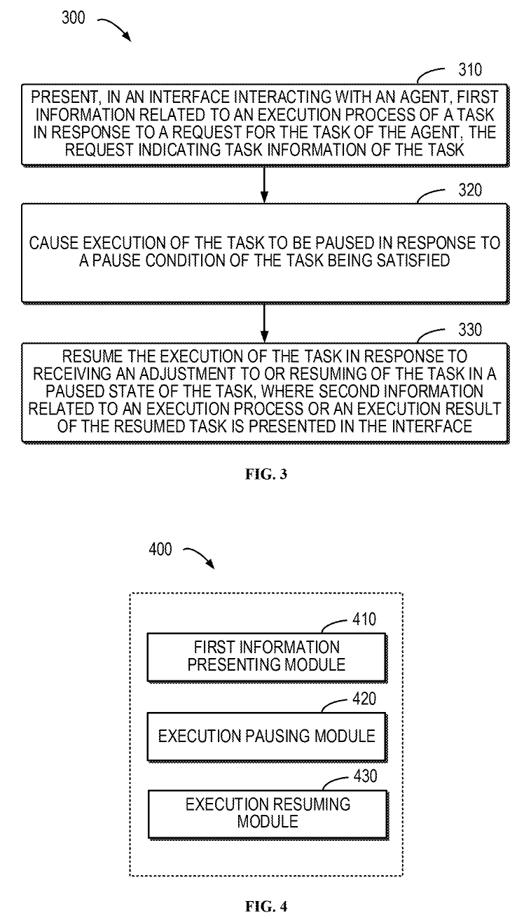

FIG. 3 illustrates a flowchart of a process 300 for task interaction according to some embodiments of the present disclosure. The process 300 may be implemented at the terminal device 110. The process 300 will be described below with reference to FIG. 1.

At block 310, the terminal device 110 presents, in an interface interacting with an agent, first information related to an execution process of a task in response to a request for the task of the agent, the request indicating task information of the task.

At block 320, the terminal device 110 causes execution of the task to be paused in response to a pause condition of the task being satisfied.

At block 330, the terminal device 110 resumes the execution of the task in response to receiving an adjustment to or resuming of the task in a paused state of the task, where second information related to an execution process or an execution result of the resumed task is presented in the interface.

In some embodiments, the process 300 further includes: presenting at least one interaction element in the interface in response to the pause condition of the task being satisfied, the at least one interaction element being at least configured to adjust or resume the task in the paused state of the task.

In some embodiments, the at least one interaction element includes at least one of the following: a first interaction element for triggering an adjustment to the task information of the task in the paused state of the task, or a second interaction element for triggering resuming the execution of the task in the paused state of the task.

In some embodiments, the interface includes a pause control during the execution of the task, and causing the execution of the task to be paused includes: causing the execution of the task to be paused in response to triggering on the pause control.

In some embodiments, resuming the execution of the task includes: resuming the execution of the task in response to receiving the adjustment to the task information, where the second information is determined based on the adjustment to the task information and the first information.

In some embodiments, the task includes at least one subtask, and causing the execution of the task to be paused in the interface includes: during the execution of the task, causing the execution of the task to be paused in response to a first subtask in the at least one subtask requiring an access permission for an information source.

In some embodiments, resuming the execution of the task includes: resuming the execution of the first subtask in response to receiving an access authorization for the information source to be accessed, where the second information is determined based on information obtained from the information source and the first information.

In some embodiments, resuming the execution of the task further includes: skipping the execution of the first subtask and continuing to execute a second subtask subsequent to the first subtask in response to receiving the resuming of the task in the paused state of the task.

In some embodiments, the task includes at least one subtask, and causing the execution of the task to be paused includes: during the execution of the task, determining that the pause condition of the task is satisfied in response to a third subtask in the at least one subtask requiring auxiliary information, and causing the execution of the task to be paused.

In some embodiments, resuming the execution of the task includes: resuming the execution of the third subtask in response to receiving input auxiliary information, where the second information is determined based on the auxiliary information and the first information.

In some embodiments, the process 300 further includes: presenting, in the interface, prompt information in association with the first interaction element, the prompt information indicating a need for the auxiliary information.

In some embodiments, the task includes at least one subtask, and causing the execution of the task to be paused includes: causing the execution of the task to be paused in response to an execution duration of a fourth subtask in the at least one subtask being longer than a first duration threshold.

In some embodiments, resuming the execution of the task includes: resuming the execution of the task in response to receiving the resuming of the task in the paused state of the task, to continue to execute the fourth subtask or start a fifth subtask subsequent to the fourth subtask, where the second information is determined based on an execution process or an execution result of the fourth or fifth subtask.

In some embodiments, the process 300 further includes: stopping the execution of the task in response to receiving triggering for stopping of the task.

In some embodiments, causing the execution of the task to be paused includes: causing the execution of the task to be paused in response to a generation of a task plan for the task, and presenting, in the interface, task information of the at least one subtask indicated by the task plan.

In some embodiments, the process 300 further includes: stopping the execution of the task in response to total execution duration of the task being longer than a second duration threshold; and presenting, in the interface, prompt information for prompting to initiate a new task.

Embodiments of the present disclosure further provide a corresponding apparatus for implementing the above method or process.

FIG. 4 illustrates a schematic structural block diagram of an apparatus 400 for task interaction according to some embodiments of the present disclosure. The apparatus 400 may be implemented as or included at the terminal device 110. Each module/component in the apparatus 400 may be implemented by hardware, software, firmware, or any combination thereof.

As shown in FIG. 4, the apparatus 400 includes a first information presenting module 410 configured to present, in an interface interacting with an agent, first information related to an execution process of a task in response to a request for the task of the agent, the request indicating task information of the task. The apparatus 400 further includes an execution pausing module 420 configured to cause execution of the task to be paused in response to a pause condition of the task being satisfied. The apparatus 400 further includes an execution resuming module 430 configured to resume the execution of the task in response to receiving an adjustment to or resuming of the task in a paused state of the task, where second information related to an execution process or an execution result of the resumed task is presented in the interface.

In some embodiments, the process 300 further includes: presenting at least one interaction element in the interface in response to the pause condition of the task being satisfied, the at least one interaction element being at least configured to adjust or resume the task in the paused state of the task.

In some embodiments, the at least one interaction element includes at least one of the following: a first interaction element for triggering an adjustment to the task information of the task in the paused state of the task, or a second interaction element for triggering resuming the execution of the task in the paused state of the task.

In some embodiments, the interface includes a pause control during the execution of the task, and the execution pausing module 420 is further configured to cause the execution of the task to be paused in response to triggering on the pause control.

In some embodiments, the execution resuming module 430 is further configured to resume the execution of the task in response to receiving the adjustment to the task information, where the second information is determined based on the adjustment to the task information and the first information.

In some embodiments, the task includes at least one subtask, and the execution pausing module 420 is further configured to: during the execution of the task, cause the execution of the task to be paused in response to a first subtask in the at least one subtask requiring an access permission for an information source.

In some embodiments, the execution resuming module 430 is further configured to resume the execution of the first subtask in response to receiving an access authorization for the information source to be accessed, where the second information is determined based on information obtained from the information source and the first information.

In some embodiments, the execution resuming module 430 is further configured to skip the execution of the first subtask and continue to execute a second subtask subsequent to the first subtask in response to receiving the resuming of the task in the paused state of the task.

In some embodiments, the task includes at least one subtask, and the execution pausing module 420 is further configured to: during the execution of the task, determine that the pause condition of the task is satisfied in response to a third subtask in the at least one subtask requiring auxiliary information, and cause the execution of the task to be paused.

In some embodiments, the execution resuming module 430 is further configured to resume the execution of the third subtask in response to receiving input auxiliary information, where the second information is determined based on the auxiliary information and the first information.

In some embodiments, the apparatus 400 further includes a prompt information presenting module configured to present, in the interface, prompt information in association with the first interaction element, the prompt information indicating a need for the auxiliary information.

In some embodiments, the task includes at least one subtask, and the execution pausing module 420 is further configured to determine that the pause condition of the task is satisfied and cause the execution of the task to be paused in response to an execution duration of a fourth subtask in the at least one subtask being longer than a first duration threshold.

In some embodiments, the execution resuming module 430 is further configured to resume the execution of the task in response to receiving a triggering of the resuming of the task in the paused state of the task, to continue to execute the fourth subtask or start a fifth subtask subsequent to the fourth subtask, where the second information is determined based on an execution process or an execution result of the fourth or fifth subtask.

In some embodiments, the apparatus 400 further includes an execution stopping module configured to stop the execution of the task in response to receiving triggering for stopping of the task.

In some embodiments, the execution pausing module 420 is further configured to cause the execution of the task to be paused in response to generation of a task plan for the task, and present, in the interface, task information of the at least one subtask indicated by the task plan.

In some embodiments, the prompt information presenting module is further configured to stop the execution of the task in response to total execution duration of the task being longer than a second duration threshold; and present, in the interface, prompt information for prompting to initiate a new task.

The units and/or modules included in the apparatus 400 may be implemented in various manners, including software, hardware, firmware, or any combination thereof. In some embodiments, one or more units and/or modules may be implemented using software and/or firmware, for example machine executable instructions stored on a storage medium. In addition to machine executable instructions or as an alternative, some or all units and/or modules in the apparatus 400 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

It should be understood that one or more steps in the above method may be performed by an appropriate electronic device or combination of electronic devices. Such an electronic device or combination of electronic devices may include, for example, the terminal device 110 and the server 130 in FIG. 1.

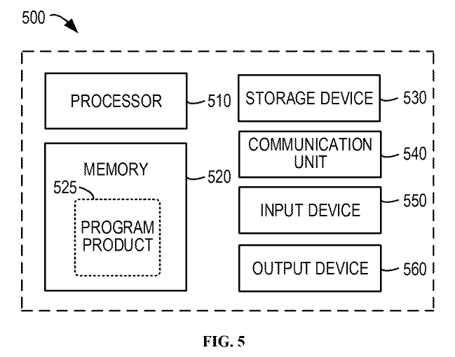

FIG. 5 illustrates a block diagram of an electronic device 500 in which one or more embodiments of the present disclosure may be implemented. It should be understood that the electronic device 500 shown in FIG. 5 is only illustrative, and should not constitute any limitation on the functions and scope of the embodiments described herein. The electronic device 500 shown in FIG. 5 may be used to implement the terminal device 110 or the server 130 of FIG. 1.

As shown in FIG. 5, the electronic device 500 is in the form of a general electronic device. The components of the electronic device 500 may include, but are not limited to, one or more processing units or processors 510, a memory 520, a storage device 530, one or more communication units 540, one or more input devices 550, and one or more output devices 560. The processing unit 570 may be an actual or virtual processor and may execute various processes based on programs stored in the memory 520. In a multiprocessor system, multiple processing units execute computer executable instructions in parallel to improve the parallel processing capability of the electronic device 500.

The electronic device 500 typically includes multiple computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk driver for reading from or writing to a removable, non-volatile disk (such as a "floppy disk"), and an optical disk driver for reading from or writing to a removable, non-volatile optical disk may be provided. In these cases, each driver may be connected to a bus (not shown) by one or more data medium interfaces. The memory 520 may include a computer program product 525, which has one or more program modules configured to perform various methods or acts of various embodiments of the present disclosure.

The communication unit 540 enables communication with other electronic devices via a communication medium. Additionally, the functions of the components of the electronic device 500 may be implemented by a single computing cluster or multiple computing machines, which may communicate via communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) as needed via the communication unit 540, the external devices such as a storage device, a display device, etc., communicate with one or more devices that enable the user to interact with the electronic device 500, or communicate with any devices (for example, a network card, a modem, etc.) that enable the electronic device 500 to communicate with one or more other electronic devices. Such communication may be performed via input/output (I/O) interfaces (not shown).

According to an illustrative implementation of the present disclosure, there is provided a computer-readable storage medium having computer-executable instructions stored thereon, where the computer-executable instructions are executed by a processor to implement the method described above. According to an illustrative implementation of the present disclosure, there is further provided a computer program product tangibly stored on a non-transitory computer-readable medium and including computer-executable instructions, which are executed by a processor to implement the method described above.

Various aspects of the present disclosure are described herein with reference to flowcharts and/or block diagrams of methods, apparatuses, devices and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, create means for implementing the functions/acts specified in one or more blocks of the flowcharts and/or block diagrams. These computer-readable program instructions may also be stored in a computer-readable storage medium, these instructions cause a computer, a programmable data processing apparatus, and/or other devices to work in a specific manner, so that the computer-readable medium storing the instructions includes an article of manufacture, which includes instructions for implementing various aspects of the functions/acts specified in one or more blocks of the flowcharts and/or block diagrams.

The computer-readable program instructions may be loaded onto a computer, another programmable data processing apparatus, or other devices, so that a series of operations and steps are performed on the computer, another programmable data processing apparatus, or other devices to generate a computer-implemented process, so that the instructions executed on the computer, another programmable data processing apparatus, or other devices implement the functions/acts specified in one or more blocks of the flowcharts and/or block diagrams.

The flowcharts and block diagrams in the drawings illustrate the possibly implemented architectures, functions and operations of the system, method and computer program product according to multiple implementations of the present disclosure. In this regard, each block in the flowchart or block diagram may represent a module, program segment or part of an instruction, which contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that performs the specified functions or acts, or may be implemented by a combination of dedicated hardware and computer instructions.

Various implementations of the present disclosure have been described above, and the above description is illustrative, non-exhaustive, and not limited to the disclosed implementations. Without departing from the scope and spirit of the described implementations, many modifications and variations will be apparent to those of ordinary skill in the art. The choice of terms used herein is intended to best explain the principles of the implementations, the practical applications or improvements to the technologies in the market, or to enable other persons of ordinary skill in the art to understand the implementations disclosed herein.

1. A method for task interaction, comprising:
presenting, in an interface interacting with an agent, first information related to an execution process of a task in response to a request for the task of the agent, the request indicating task information of the task;
causing execution of the task to be paused in response to a pause condition of the task being satisfied; and
resuming the execution of the task in response to receiving an adjustment to or resuming of the task in a paused state of the task, wherein second information related to an execution process or an execution result of the resumed task is presented in the interface.

2. The method of claim 1, further comprising:
presenting at least one interaction element in the interface in response to the pause condition of the task being satisfied, the at least one interaction element being at least configured to adjust or resume the task in the paused state of the task.

3. The method of claim 2, wherein the at least one interaction element comprises at least one of the following:
a first interaction element for triggering an adjustment to the task information of the task in the paused state of the task, or
a second interaction element for triggering resuming the execution of the task in the paused state of the task.

4. The method of claim 1, wherein the interface comprises a pause control during the execution of the task, and causing the execution of the task to be paused comprises:
causing the execution of the task to be paused in response to triggering on the pause control.

5. The method of claim 1, wherein resuming the execution of the task comprises:
resuming the execution of the task in response to receiving the adjustment to the task information,
wherein the second information is determined based on the adjustment to the task information and the first information.

6. The method of claim 1, wherein the task comprises at least one subtask, and wherein causing the execution of the task to be paused comprises:
causing the execution of the task to be paused, during the execution of the task, in response to a first subtask in the at least one subtask requiring an access permission for an information source.

7. The method of claim 6, wherein resuming the execution of the task comprises:
resuming the execution of the first subtask in response to receiving an access authorization for the information source to be accessed,
wherein the second information is determined based on information obtained from the information source and the first information.

8. The method of claim 7, wherein resuming the execution of the task further comprises:
in response to receiving the resuming of the task in the paused state of the task,
skipping the execution of the first subtask, and
continuing to execute a second subtask subsequent to the first subtask.

9. The method of claim 1, wherein the task comprises at least one subtask, and wherein causing the execution of the task to be paused comprises:
causing the execution of the task to be paused, during the execution of the task, in response to a third subtask in the at least one subtask requiring auxiliary information.

10. The method of claim 9, wherein resuming the execution of the task comprises:
resuming the execution of the third subtask in response to receiving the auxiliary information, wherein the second information is determined based on the auxiliary information and the first information.

11. The method of claim 9, further comprising:
presenting, in the interface, prompt information in association with the first interaction element, the prompt information indicating a need for the auxiliary information.

12. The method of claim 1, wherein the task comprises at least one subtask, and causing the execution of the task to be paused comprises:
causing the execution of the task to be paused in response to an execution duration of a fourth subtask in the at least one subtask being longer than a first duration threshold.

13. The method of claim 12, wherein resuming the execution of the task comprises:
resuming the execution of the task in response to receiving the resuming of the task in the paused state of the task, to continue to execute the fourth subtask or start a fifth subtask subsequent to the fourth subtask,
wherein the second information is determined based on an execution process or an execution result of the fourth or fifth subtask.

14. The method of claim 12, further comprising:
stopping the execution of the task in response to receiving triggering for stopping of the task.

15. The method of claim 1, wherein causing the execution of the task to be paused comprises:
in response to generation of a task plan for the task,
causing the execution of the task to be paused, and
presenting, in the interface, task information of the at least one subtask indicated by the task plan.

16. The method of claim 1, further comprising:
in response to total execution duration of the task being longer than a second duration threshold,
stopping the execution of the task, and
presenting, in the interface, prompt information for prompting to initiate a new task.

17. An electronic device, comprising:
at least one processor; and
at least one memory, the at least one memory is coupled to the at least one processor and stores instructions executable by the at least one processor, the instructions, when executed by the at least one processor, cause the electronic device to perform acts comprising:
presenting, in an interface interacting with an agent, first information related to an execution process of a task in response to a request for the task of the agent, the request indicating task information of the task;
causing execution of the task to be paused in response to a pause condition of the task being satisfied; and
resuming the execution of the task in response to receiving an adjustment to or resuming of the task in a paused state of the task, wherein second information related to an execution process or an execution result of the resumed task is presented in the interface.

18. The electronic device of claim 17, wherein the acts further comprise:
presenting at least one interaction element in the interface in response to the pause condition of the task being satisfied, the at least one interaction element being at least configured to adjust or resume the task in the paused state of the task.

19. The electronic device of claim 17, wherein the task comprises at least one subtask, and wherein causing the execution of the task to be paused comprises:
causing the execution of the task to be paused, during the execution of the task, in response to a first subtask in the at least one subtask requiring an access permission for an information source.

20. A non-transitory computer-readable storage medium, storing computer-executable instructions thereon, the computer-executable instructions being executable by a processor to perform acts comprising:
presenting, in an interface interacting with an agent, first information related to an execution process of a task in response to a request for the task of the agent, the request indicating task information of the task;
causing execution of the task to be paused in response to a pause condition of the task being satisfied; and
resuming the execution of the task in response to receiving an adjustment to or resuming of the task in a paused state of the task, wherein second information related to an execution process or an execution result of the resumed task is presented in the interface.
